(19) United States
(12) Patent Application Publication
(10) Pub. No.: US 2024/0289091 A1
(43) Pub. Date: Aug. 29, 2024

(54) A COMPUTER-IMPLEMENTED METHOD AND A DATA PROCESSING HARDWARE FOR PROCESSING SENSOR DATA POINTS

(71) Applicant: Continental Autonomous Mobility Germany GmbH, Ingolstadt (DE)

(72) Inventors: Wassim Suleiman, Kriftel (DE); Nicolai Glatz, Frankfurt am Main (DE); Christopher Brown, Seligenstadt (DE)

(73) Assignee: Continental Autonomous Mobility Germany GmbH, Ingolstadt (DE)

(21) Appl. No.: 18/574,047

(22) PCT Filed: Jun. 14, 2022
(86) PCT No.: PCT/EP2022/066172

§ 371 Date: Dec. 25, 2023

(30) Foreign Application Priority Data
Jun. 30, 2021 (EP) 21182865.2

(51) Int. Cl. G06F 7/08

(52) U.S. Cl. CPC G06F 7/08

(57) ABSTRACT

This disclosure relates to a computer-implemented method for processing sensor data points by means of a data processing hardware where a distributions buffer for storing an initial plurality of Gaussian distributions is initialized, each Gaussian distribution of the initial plurality of Gaussian distributions including an initial plurality of sensor data points received sequentially from at least one sensor and having an associated predetermined distribution distance threshold, and where the distributions buffer is sequentially updated for a number n of new sensor data points based on a distribution distance condition, generating an updated plurality of Gaussian distributions including either a new Gaussian distribution, or an updated single Gaussian distribution or an updated merged Gaussian distribution.

### CROSS-REFERENCE TO RELATED APPLICATIONS

The present application is a National Stage Application under 35 U.S.C. § 371 of International Patent Application No. PCT/EP2022/066172 filed on Jun. 14, 2022, and claims priority from European Patent Application No. 21182865.2 filed on Jun. 30, 2021, in the European Patent Office, the disclosures of which are herein incorporated by reference in their entireties.

### TECHNICAL FIELD

The invention is related to a computer-implemented method and a data processing hardware for processing sensor data points.

### BACKGROUND

Raw data points, alternatively called raw sensor data or sensor data points, refer to the data received form sensors.

Lightweight environment maps are maps providing all details of the environment using a small memory footprint (RAM usage) and low Central Processing Unit (CPU) usage, overall a low usage of system resources.

Using sensors for providing various types of data is increasingly used in a wide range of fields of activity and technology. Generally speaking, the sensors provide a large number of raw data points each processing cycle, the raw data points being processed in order to provide relevant information. The processing of the raw data points includes the creation of some sort of data structures according to the needs, the data structures being used to output of the data processing of the sensors data points of each processing cycle.

In some cases, the output the data processing of the raw data points is used to build environment mapping. One example is to describe static objects in the environment, where the sensor(s) generate “dense” raw data points from the objects in the scene, such as in the case of automotive industry or in the case of management of warehouses or other spaces where a large number of objects are stored.

In other cases, the output the data processing of the raw data points is used as such to be transmitted to a decision maker without generating an environment map. One example is medical field where the sensors collect data from the patient and send them to a medical device to be further analyzed by a medical specialist.

The first disadvantage is that the distribution of the data received from the sensors is not preserved during the processing of the large number of raw points. The second disadvantage stems from the first. In the absence of preserving the distribution of the data received from the sensors, saving a large number of raw points leads to large volumes of data for the processing of which increasingly large memory and processing power of the hardware unit or units are required.

In the particular case of the automotive industry, sensors data comes from modern sensors such as LiDAR, Radar, and ultrasound used for environment mapping of static objects from the scene, where they provide a large number of points each processing cycle.

A map of the environment is usually constructed using these sensors data points, e.g., grid maps or point cloud. The creation and update of the map require large memory and computation, which limits the possibilities of building the architecture of the electronic control units of the vehicle.

The problem to be solved by the present disclosure is to provide a more efficient method for processing sensor data points received from the sensors collecting data, in particular from static objects in the environment, preserving the distribution of the sensor data in a predetermined data structure, by using less memory and less computing resources compared to the existing solutions.

### SUMMARY

In order to solve the problem, the inventors conceived in a first aspect a computer-implemented method for processing sensor data points including four steps carried out by means of a data processing hardware:
1.1. Initializing a distributions buffer G for storing an initial plurality of Gaussian distributions gₙ, each Gaussian distribution g comprising an initial plurality of sensor data points Pr received sequentially from at least one sensor, each Gaussian distribution g having an associated predetermined distribution distance threshold Ddₘᵢₙ;
1.2. Sequentially acquiring a new sensor data point Pr_{new} from the at least one sensor and computing a distribution distance Dd between the new sensor data point Pr_{new} and each Gaussian distribution g;
1.3. Verifying for each Gaussian distribution g if the distribution distance Dd fulfills a distribution distance condition Dd Ddₘᵢₙ, respectively the distribution distance Dd<the associated predetermined distribution distance threshold Ddₘᵢₙ;
   1.3.1. If no Gaussian distribution g fulfills the distribution distance condition Dd<Ddₘᵢₙ, generating a new Gaussian distribution g_{new}, including the new sensor data point Pr_{new},
   1.3.2. If the distribution distance condition Dd<Ddₘᵢₙ is fulfilled by a single Gaussian distribution g₁, updating said single Gaussian distribution g₁ by adding the new sensor data point Pr_{new}, generating an updated Gaussian distribution g_{1-updated},
   1.3.3. If the distribution distance condition Dd<Ddₘᵢₙ is fulfilled by at least two Gaussian distributions g₁, g₂, . . . gₘ, merging the at least two Gaussian distributions g₁, g₂ . . . gₘ, generating a merged Gaussian distribution gₘ-merged, and updating said merged Gaussian distribution g_{m-merged} by adding the new sensor data point Pr_{new}, generating an updated merged Gaussian distribution g_{m-merged-updated},
1.4. Updating the initial plurality of Gaussian distributions gₙ by including:
   either the new Gaussian distribution g_{new}, or
   the updated single Gaussian distribution g_{1-updated}, or
   the updated merged Gaussian distribution g_{m-merged-updated},
and generating an updated plurality of Gaussian distributions g_{n-updated} in the distributions buffer G,
the steps 1.2., 1.3., and 1.4. are repeated for a number n of new sensor data points Pr_{n-new}.

In a second aspect of the present disclosure it is provided a data processing hardware being configured to carry out the steps of the computer-implemented method for processing sensor data points.

The present disclosure extends to any novel aspects or features described and/or illustrated herein. Any feature in one aspect of the present disclosure may be applied to other aspects of the present disclosure, in any appropriate combination. Particular combinations of the various features of the present disclosure can be implemented and/or supplied and/or used independently.

The main advantages of this present disclosure are the following:
generating a predetermined data structure for the sensor data points received from one or multiple sensors (e.g., ultrasound, radar, etc.) as input and preserving the predetermined data structure during the processing of the sensor data points for successive processing cycles.
saving memory and computing power resources of the data processing hardware by using the predetermined data structure during the processing of the raw point cloud for successive processing cycles.
due to savings of memory and computing power resources, enabling use of the present disclosure to process raw sensors data by a wider range of data processing hardware, in particular the small-sized data processing hardware, which in its turn enables the use of the present disclosure in a wider range of situations, for example by providing some sensors with the data processing hardware instead of sending the raw sensor data to be processed elsewhere.

### BRIEF DESCRIPTION OF THE DRAWINGS

The present disclosure is explained in more detail below with reference to the figures of exemplary embodiments, wherein:

FIG. 1 represents schematically the method for processing sensor data points according to the present disclosure;

FIG. 2 represents an example of scenery in one of the embodiments using the method of the present disclosure;

FIG. 3 represents the results of applying prior art methods for the scenery of FIG. 2;

FIG. 4 represents a schematic illustration of applying the method in the same embodiment using the example of scenery of FIG. 2, for constructing ellipses from the points shown in FIG. 2;

FIG. 5 represents a schematic illustration of the method according to the same embodiment for the scenery of FIG. 2, namely the construction of objects (here, convex hulls) from the ellipses;

FIG. 6 represents a schematic figure in another embodiment of the present disclosure for the construction of objects based on the ellipses.

### DETAILED DESCRIPTION

Raw sensor data usually embeds large scale unclean and useless data. The large quantity of unwanted and useless data leads to unnecessary increase of memory and computing power which is not desired in a constrained sensor network.

Thus, the raw sensor data need to undergo first data cleaning processing, outputting cleaned sensor data which is processed to obtain relevant information. Further, the proposed approach uses Gaussian distributions to process raw sensor data. Since the Gaussian distributions are built sequentially, there is no need to save the raw points.

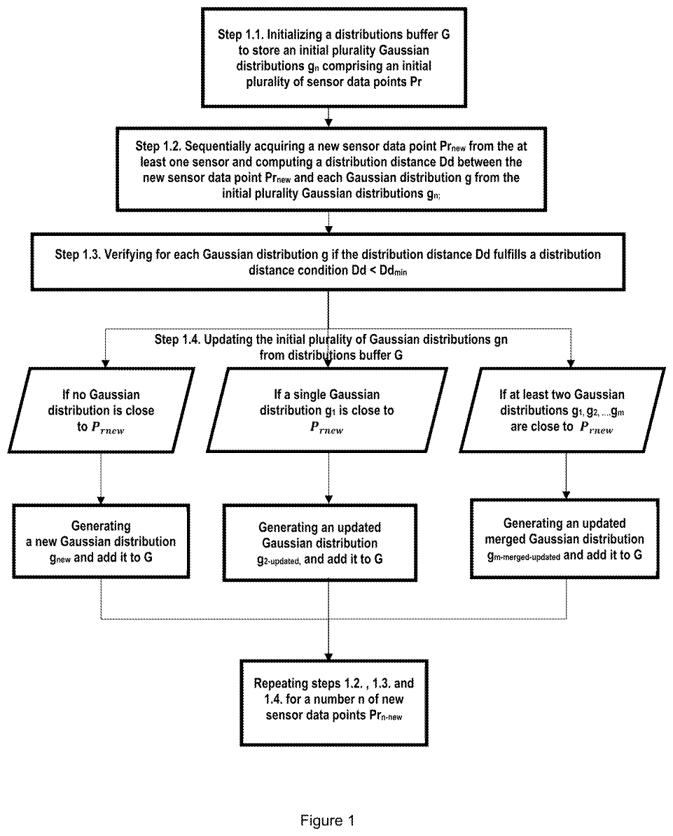

With reference to FIG. 1, the computer-implemented method for processing sensor data points, according to the present disclosure includes four steps carried out by means of a data processing hardware.

In step 1.1. a distributions buffer G is initialized to store an initial plurality of Gaussian distributions gₙ, each Gaussian distribution g including an initial plurality of sensor data points Pr received sequentially from at least one sensor.

The sensor data points Pr used in the method are received, for example, from one or multiple sensors, or from a processing unit as a result of the fusion or other type of processing of the sensor data points Pr received form the sensors, or from any other source providing sensor data points. Non-limiting examples of sensors include: ultrasound sensors, radar sensors, location sensors, such as GPS, movement sensors, such as accelerometer, gyroscope, camera sensors, light sensors, microphones, proximity sensors, magnetometers, sensors for measuring temperature, pressure, humidity, medical parameters of the body, chemical and biochemical substances, and neural signals, also infrared sensors, IR cameras, motion detectors, measuring the distance to nearby objects, presence of smoke and gases, moisture sensors.

The sensor data points Pr include any of the following type: sensor data points Pr having two coordinates x, y, sensor data points, Pr having three coordinates x, y, z, or sensor data points Pr having two or three coordinates and having additional features, such as reflection amplitude, direction, radial velocity, acceleration. The sensor data points Pr also include errors, the errors having the same number of coordinates as the sensor data points Pr, i.e., two coordinates x, y, or three coordinates x, y, z.

Gaussian distributions gₙ are defined by mean and covariance, for example for 2D sensor data points, with x and y coordinates, the mean is a vector of two coordinates and the covariance matrix is a symmetric 2×2 matrix, i.e., in such case 5 floating numbers are required to represent the distribution. Each Gaussian distribution g has an associated predetermined distribution distance threshold D_{dmin}.

In step 1.2. a new sensor data point Pr_{new} is sequentially acquired from the at least one sensor. The data processing hardware computes a distribution distance Dd between the new sensor data point Pr_{new} and each Gaussian distribution g from the initial plurality of Gaussian distributions gₙ.

Further on, in step 1.3. the data processing hardware verifies for each Gaussian distribution g if the distribution distance Dd fulfills a distribution distance condition Dd<Ddₘᵢₙ, respectively if the distribution distance Dd<the associated predetermined distribution distance threshold Ddₘᵢₙ.

There are three mutual excluding possibilities:
1.3.1 If no Gaussian distribution g fulfills the distribution distance condition Dd<Ddₘᵢₙ, a new Gaussian distribution g_{new} is generated, including the new sensor data point Pr_{new},
1.3.2 If the distribution distance condition Dd<Ddmin is fulfilled by a single Gaussian distribution g1, the single Gaussian distribution g1 is updated by adding the new sensor data point Prnew, generating an updated single Gaussian distribution g1-updated,
1.3.3. If the distribution distance condition Dd<Ddmin is fulfilled by at least two Gaussian distributions g1, g2, . . . gm, the at least two Gaussian distributions g1, g2 . . . gm are merged, generating a merged Gaussian distribution gm-merged, and the merged Gaussian distribution gm-merged is updated by adding the new sensor data point Pr_{new}, generating an updated merged Gaussian distribution g_{m-merged-updated}.

In the final step 1.4., the initial plurality of Gaussian distributions gₙ from the distributions buffer G is updated by including:
either the new Gaussian distribution gnew or
the updated single Gaussian distribution g1-updated or
the updated merged Gaussian distribution gm-merged-updated.

The steps 1.2., 1.3., and 1.4. are repeated for a number n of new sensor data points Pr_{n-new}.

At the end of the method, an updated plurality of Gaussian distributions g_{n-updated} is generated in the distributions buffer G.

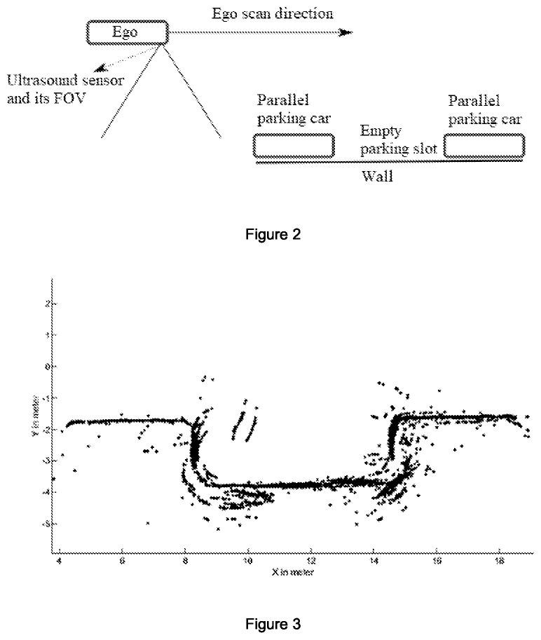

The main advantage of the updated plurality of Gaussian distributions g_{n-updated} is that it defines a predetermined data structure for the plurality of sensor data points which are received from the sensors based on Gaussian distributions and predetermined distribution distance thresholds D_{dmin}, and preserves the respective predetermined data structure during the processing of the sensor data points for successive processing cycles. The main advantage stems from using the features of the Gaussian distributions that filter plurality of sensor data points and remove outliers, eliminating the need to save the plurality of sensor data points, as depicted in the embodiment represented in FIG. 2.

The applying the method of the present disclosure has the advantage of saving memory and computing power resources of the data processing hardware by using the predetermined data structure during the processing of the raw point cloud for successive processing cycles.

Further on, due to savings of memory and computing power resources, the present disclosure has the advantage of enabling the processing of raw sensors data by a wider range of data processing hardware, in particular the small-sized data processing hardware, which in its turn enables the use of the present disclosure in a wider range of situations.

Before detailing some examples of use of the present disclosure in various fields of technology it is convenient to present some embodiments of the method of the present disclosure, because the large variety of the embodiments is the one that enables use of the invention in a wide range of fields.

In an embodiment, the distribution distance Dd is a Euclidian distance between the new sensor data point Pr_{new} and the mean μ_{g} of each Gaussian distribution g.

A particular advantage of using the Euclidian distance is saving the computing power resources, enabling use of the present disclosure to process raw sensors data by a wider range of data processing hardware. Saving computer power resources has the further advantage that it reduces the costs of the computation.

In another embodiment, in order to further save computing resources, the distribution distance is a norm one distance, i.e., using 1 norm defining, for example in two dimensions as distribution distance Dd=|x1−x2|+|y1−y2|.

In another embodiment, the distribution distance Dd is the probability of the new sensor data point Pr_{new} in respect to each Gaussian distribution g of the initial plurality Gaussian distributions gₙ as follows:

$${D}_{d} = prob ( {Pr}_{new} , {g}_{n} ) = 𝒩 ( {Pr}_{new} ; {μ}_{n} , {\sum }_{n} ) = {( 2 π )}^{- \frac{k}{2}} det {( {\sum }_{n} )}^{- \frac{1}{2}} exp ( - \frac{1}{2} {( P {r}_{new} - {μ}_{n} )}^{T} {\sum }_{n}^{- 1} ( P {r}_{new} - {μ}_{n} ) )$$

where:
[symbol] (Pr_{new}; μₙ, Σₙ) is the probability that the new point Pr_{new} is generated from each Gaussian distribution g;
Pr_{new} is a new sensor data point, being a vector of k entries;
μₙ is the mean of each Gaussian distribution g, being a vector of k entries;
Σₙ is the covariance of each Gaussian distribution g, being a (k×k) matrix;
   ^{T} is the transpose.

In this embodiment, the new points Pr_{new} are more likely to belong to each Gaussian distribution g which yields the higher probability in respect to previous embodiment.

In another embodiment, the computing of the distribution distance Dd is carried out by calculating the normalized probability of the point Pr_{new} with respect to each Gaussian distribution g of the initial plurality Gaussian distributions gₙ, as follows

$${D}_{d} = \frac{Prob ( {Pr}_{new} , {g}_{n} )}{c}$$

where c is a normalization factor.

In this embodiment, the new points Pr_{new} are also more likely to belong to the distribution which yields the higher probability in respect to previous embodiment, the distribution distance Dd being invers proportionally with the probability.

The particular advantage of this embodiment over the previous one is that the normalization factor c can be chosen so that for the new points Pr_{new} placed inside an equi-probability ellipse, namely the ellipse for which prob(Pr_{new}, gₙ)=C, the normalization factor c>1, whereas for the new points Pr_{new} placed outside the equi-probability ellipse the normalization factor c<1.

In another embodiment, the distribution distance Dd is computed using the Mahalanobis distance formula. The use of the Mahalanobis distance formula applies irrespective of defining or not the distribution distance Dd as the probability of the new sensor data point Pr_{new} as well as irrespective of computing or not the distribution distance Dd as Euclidian distance between the new sensor data point Pr_{new} and the mean μ_{g} of each Gaussian distribution g.

Using the Mahalanobis distance formula is in particular advantageous since is less computationally expensive as the other distances excepting Euclidian distance.

In another embodiment, the sequential update of the updated single Gaussian distribution g_{1-updated}, and the updated merged Gaussian distribution g_{m-merged-updated} by sequentially adding a number n of new sensor data points Pr_{n-new} are carried out by the formulas:

$${μ}_{{g}_{n - updated}} = \frac{n - 1}{n} {μ}_{{g}_{n}} + \frac{1}{n} {Pr}_{n - new}$$

$$and$$

$${\sum }_{{g}_{n - updated}} = \frac{n - 2}{n - 1} {\sum }_{{g}_{n}} + \frac{1}{n} Δ {Δ}^{T}$$

$$and$$

$$Δ = {Pr}_{{n - new}_{}} - {μ}_{{g}_{n}}$$

where:
μ_{gn} is the mean of any of the single Gaussian distribution g₁, and the merged Gaussian distribution g_{m-merged};
Σ_{gn} is the covariance of any of the single Gaussian distribution g₁, and a merged Gaussian distribution g_{m-merged};
μ_{gn-updated} is the mean of any of the updated single Gaussian distribution g_{1-updated}, and the updated merged Gaussian distribution g_{m-merged-updated},
Σ_{gn-updated} is the covariance of any of the updated single Gaussian distribution g_{1-updated}, and the updated merged Gaussian distribution g_{m-merged-updated},
^{T} is the transpose.

The sequential updating embodiment is described only for the purposes of illustrating the principles of the present disclosure, however any sequential updating leading to the same outcome may be applied without departing from such principles.

In another embodiment of the sequential update of the updated single Gaussian distribution g_{1-updated}, and the updated merged Gaussian distribution g_{m-merged-updated} by sequentially adding a number n of new sensor data points Pr_{n-new}, which is even more numerically stable, is carried out by formula:

$${μ}_{gn - updated} = {μ}_{{g}_{n}} + \frac{1}{n} ( P {r}_{n - new} - {μ}_{{g}_{n}} )$$

For the mean and for the variance one updates a variable S is used as follows:

$${S}_{gn - updated} = {S}_{gn} + Δ {Δ}_{updated}^{T}$$

where
Δ=Pr_{n-new}−μ_{gn}
Δ_{updated}=Pr_{n-new}−μ_{gn-updated}
and S is related to Σ through

$$\sum = \frac{1}{n} S$$

The sequentially adding a number n of new sensor data points Pr_{n-new} applies irrespective of defining or not the distribution distance Dd as the probability of the new sensor data point Pr_{new}, as well as irrespective of computing or not the distribution distance Dd as Euclidian distance between the new sensor data point Pr_{new} and the mean μ_{g} of each Gaussian distribution g, as well as irrespective of computing or not the distribution distance Dd using the Mahalanobis distance formula.

In another embodiment, the new sensor data point Pr_{new} is provided with a covariance matrix Σ_{Pr}_{_{new}}, forming a sensor data points Gaussian distribution N_{Pr}_{_{new}} (μ_{Pr}_{_{new}}, ΣPr_{new}) and the distribution distance Dd is computed between each Gaussian distribution g and said sensor data points Gaussian distribution N_{Pr}_{_{new}} using the Kullback-Leibler divergence or the Bhattacharyya distance.

In another embodiment, the merging of the at least two Gaussian distributions g₁, g₂ . . . gₘ is carried out by successive merging pairs of two distributions from at least two Gaussian distributions g₁, g₂ . . . gₘ generating a merged Gaussian distribution g_{m-merged} and by weighting the mean and variance of the two distributions from the respective pairs of two distributions. The successive merging is carried out as follows:
selecting a pair of distributions from at least two Gaussian distributions g₁, g₂ . . . gₘ,
generating a first intermediary merged Gaussian distribution g_{m-merged-intermediary} by weighting the mean and variance of the two distributions from the pair,
selecting another distribution from at least two Gaussian distributions g₁, g₂ . . . gₘ and merging it with the intermediary merged Gaussian distribution g_{m-merged-intermediary} generating a second intermediary merged Gaussian distribution g_{m-merged-intermediary},
continuing the generation of further intermediary merged Gaussian distribution g_{m-merged-intermediary} until all the distributions from at least two Gaussian distributions g₁, g₂ . . . gₘ are included in the merge.

The successive merging is carried out according to the formula:

$${μ}_{{g}_{m - merged}} = \frac{n 1}{n 1 + n 2} {μ}_{g 1} + \frac{n 2}{n 1 + n 2} {μ}_{g 2}$$

$${\sum }_{{g}_{m - merged}} = \frac{n 1}{n 1 + n 2} ( {\sum }_{g 1} + {\tilde{Δ}}_{1} {\tilde{Δ}}_{1}^{T} ) + \frac{n 2}{n 1 + n 2} ( {\sum }_{g 2} + {\tilde{Δ}}_{1} {\tilde{Δ}}_{2}^{T} )$$

where:
\tilde{Δ}₁=μ_{g1}−μ_{g}_{_{m-merged}}
and \tilde{Δ}₂=μ_{g2}−μ_{g}_{_{m-merged}}
μ_{g1}, μ_{g2} are the means of the two distributions from the pair;
Σ_{g1}, Σ_{g2} are the variance of the two distributions from the pair;
μ_{gm-merged} is the mean of merged Gaussian distribution g_{m-merged};
Σ_{gm-merged} is the variance of merged Gaussian distribution g_{m-merged}.

The method of the present disclosure in any of the embodiments described above is applied in different field of technology. Depending on the purpose of using the method, different type and number of the sensors are used and particular embodiments from the above can lead to better results. For all possible uses of the method, the advantage of saving memory and computing power enables for example by providing some sensors with the data processing hardware instead of sending the raw sensor data to be processed elsewhere as well as enables the use of small sized hardware processing units.

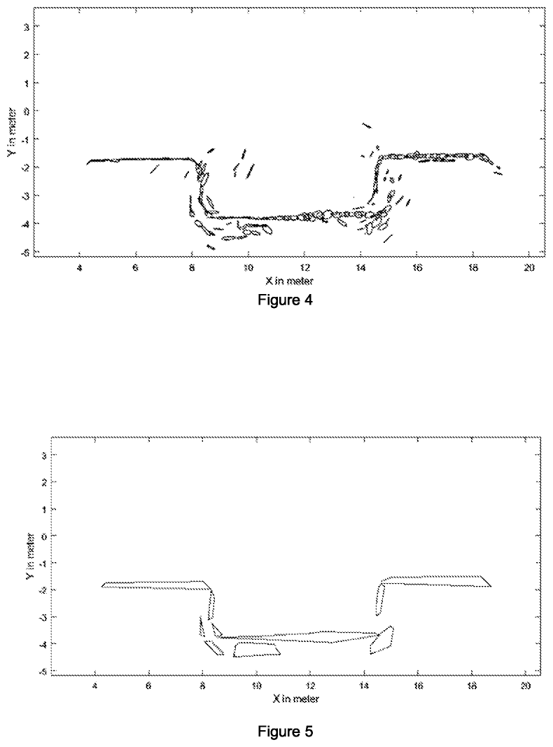

As seen in FIG. 2, FIG. 4, FIG. 5, the updated plurality of Gaussian distributions g_{n-updated} generated by the method can be used in intelligent parking management, in smart transportation system, where the drivers can easily check to find out which parking has free spaces, or in intelligent warehouse management where one can be seen where free spaces are available. The new sensor data points Prn new is sequentially acquired from the sensors governing these types of applications such as: GPS sensors for location, accelerometers for speed, gyroscopes for direction, RFIDs for vehicle identification, infrared sensors for detecting passengers and vehicles, and cameras for recording vehicle movement.

The updated plurality of Gaussian distributions g_{n-updated} generated by the method can be used in smart transport applications and in traffic surveillance and management applications which manage daily traffic in cities using sensors and intelligent information processing systems, to minimize traffic congestion, ensure easy and hassle-free parking, and avoid accidents by properly routing traffic and spotting drunk drivers, and estimating the traffic conditions, traffic patterns so that future traffic conditions can be estimated, and vehicle tracking system for traffic surveillance may be implemented. Also, the updated plurality of Gaussian distributions g_{n-updated} generated by the method can be used in applications that ensure safety of people travelling in their vehicles, and accident detection applications using the corresponding sensors.

In case the new sensor data points Pr_{new} are sequentially acquired from the sensors collecting data from patients, the updated plurality of Gaussian distributions g_{n-updated} generated by the steps of the method can be used in applications dedicated to continuously monitor and record their health conditions and transmit warnings in case any abnormal indicators are found.

With reference to FIG. 2, FIG. 3, FIG. 4, FIG. 5, it is shown a typical example of using the method of the present disclosure in any of the previous embodiments in intelligent parking management or intelligent warehouse management is to build, where a lightweight representation of a static environment comprising a plurality of objects oₙ from a buffer O is created by using the initial plurality Gaussian distributions gₙ, and the updated plurality of Gaussian distributions g_{n-updated} from the distributions buffer G. The plurality of objects oₙ from the buffer O could be any mathematical type example polygons, convex-hulls etc. This mathematical representation corresponds to one or part of a real object. For example a parking car can be represented by one or more polygons. Each object is built from distributions which are similar based on the distance measure.

Such lightweight representation of the static environment is used when it is needed to spot a free space between objects, such as in the case of automotive industry or in the case of management of warehouses or other spaces where a large number of objects are stored.

FIG. 2 depicts the scenery of particular example of this embodiment in which the ego vehicle scans two parallel vehicles parked parallelly to a wall, having an empty parking slot between them.

FIG. 3 depicts the “dense” data points from the objects in the scenery according to prior art, namely 2D data points acquired from 12 ultrasound sensors of the ego vehicle.

In step 8.1. it is defined an initial plurality of objects oₙ₋ᵢₙᵢₜᵢₐₗ as a list of distribution from the initial plurality Gaussian distributions gₙ, e.g., an object o comprises the distributions g1, g2, g5, specifically o={g1, g2, g5}.

In step 8.2. it is received from the updated plurality of Gaussian distributions g_{n-updated}:
either the new Gaussian distribution g_{new}, or
the updated single Gaussian distribution g_{1-updated}, or
the updated merged Gaussian distribution g_{m-merged-updated}, referred to for the ease of understanding as an updated distribution.

Then, it is computed an object distance Do from the updated distribution to each object o of the initial plurality of objects oₙ₋ᵢₙᵢₜᵢₐₗ. Thus, for the above example the object distance Do is defined as the smallest distance between updated distribution g and all distributions belonging to object o, i.e., distance (o, g)=min {distance(g1, g), distance(g2, g), distance(g5, g)}, where o={g1, g2, g5}, the distance between distributions being calculated as defined above using the Kullback-Leibler divergence or the Bhattacharyya distance.

In step 8.3. it is verified if the updated distribution satisfies an object distance condition, namely if the object distance Do<a predetermined object distance threshold Doₘᵢₙ (Do<Doₘᵢₙ) and then it is updated the initial plurality of objects oₙ₋ᵢₙᵢₜᵢₐₗ, generating an updated plurality of objects o_{n-updated} depending on the type of updated distribution, as follows:
When the updated distribution is the new Gaussian distribution g_{new}, the updating of the initial plurality of objects oₙ₋ᵢₙᵢₜᵢₐₗ is carried out as follows:
   if the updated distribution does not satisfy the object distance condition (Do<Doₘᵢₙ) in respect to any object from the initial plurality of objects oₙ₋ᵢₙᵢₜᵢₐₗ, a new object o_{new} is generated by assigning the new Gaussian distribution g_{new} and the new object o_{new} is saved in the objects buffer O;
   if the updated distribution satisfies the object distance condition (Do<Doₘᵢₙ) in respect to the single object o₁, the single object o₁ is updated by assigning the new Gaussian distribution g_{new}, generating an updated single object o_{1-updated}, and the updated single object o_{1-updated} is saved in the objects buffer O. For the above example, where the object is defined as a list of Gaussian distribution o={g1, g2, g5}, after assigning the Gaussian distribution, the object becomes o={g1, g2, g5, g}. The updating the convex-hull representation may be carried out by any convex hull creation algorithm by selecting the specific points to represent each respective distribution from the corresponding object o as it is described below in the embodiments.
   if the updated distribution satisfies the object distance condition (Do<Doₘᵢₙ) in respect to multiple objects oₘ of the initial plurality of objects oₙ₋ᵢₙᵢₜᵢₐₗ, the multiple objects oₘ are merged, generating a merged object o_{m-merged}, the new Gaussian distribution g_{new} are assigned to the merged object o_{m-merged} generating an updated merged object o_{m-merged-updated} which is saved in the objects buffer O.
For the above example, where there is a first object defined as a list of Gaussian distributions o={g1, g2, g5}, and a second object o′={g3, g10}, after merging the first object o with the second object o′ it is obtained a merged object defined as o″={g1, g2, g5, g3, g10}.
When the updated distribution is the updated single Gaussian distribution g_{1-updated}, the updating of the initial plurality of objects oₙ₋ᵢₙᵢₜᵢₐₗ is carried out by updating the representation of corresponding the object o comprising the single Gaussian distribution g₁, generating an updated object o_{updated}, and saving the updated object o_{updated} in the objects buffer O;
When the updated distribution is the updated merged Gaussian distribution g_{m-merged-updated}, the updating of the initial plurality of objects oₙ₋ᵢₙᵢₜᵢₐₗ is carried out as follows:
   if the updated distribution satisfies the object distance condition (Do<Doₘᵢₙ) in respect to the single object o₁, the representation of the single object o₁ is updated by including the updated distribution generating an updated single object o_{1-updated}, and the updated single object o_{1-updated} is saved in the objects buffer O;
   if the updated distribution satisfies the object distance condition in respect to multiple objects oₘ of the initial plurality of objects oₙ₋ᵢₙᵢₜᵢₐₗ, the multiple objects oₘ are merged, generating a merged object o_{m-merged}, and updated including the updated distribution generating an updated merged object o_{m-merged-updated}, which is saved in the objects buffer O;

In step 8.4. the lightweight representation of the static environment is created and permanently updated by exporting from the objects buffer O:
either the at least one new object o_{new}, or
the updated object o_{updated}, or
the merged object o_{m-merged} into a user interface for immediate use.

The steps 8.2. to 8.4. are repeated for the number n of new sensor data points Pr_{n-new}.

FIG. 4 represents the results of applying the method for processing sensor data points of the prior art for a particular example of the scenario of FIG. 3, representing 22093 raw data points each having 3 coordinates (x, y, dir “reflection direction”), where only x and y coordinates are represented graphically for simplicity.

The distributions presented in the FIG. 5 illustrate the result of the computer-implemented method for processing sensor data points according to the invention. Thus, a total of 320 distributions are used to represent 22093 raw data points.

Each of the 320 distributions require 5 floating points to be saved. That means a total of 5*320=1600 float numbers are required to build the lightweight representation of a static environment comprising the plurality of objects oₙ.

According to the prior art, a total of (2 for each coordinate)*22093=44186 float numbers are required to represent the raw points of the static environment comprising a plurality of objects oₙ.

Consequently, the compressed map, specifically the lightweight representation of the static environment comprising a plurality of objects oₙ, has only approximately 3.6%=1600*100/44186 of the size compared to the uncompressed data. In this example almost 96.4% of the size, of the memory and computing power resources of the data processing hardware is saved by using the predetermined data structure during the processing of the raw data points cloud for successive processing cycles using the method according to the present disclosure.

In other words, compression ratio=uncompressed/compressed is almost 28. i.e., the compressed data is almost 28 times smaller than the uncompressed one.

It is to be noted that the compression ratio depends oₙ the density of the sensor data points and the distributions of the clutter and measurements-error. If the later distributions are gaussians then computer-implemented method for processing sensor data points according to the present disclosure to represent the sensor data points will result in a better compression rate.

Different representations of the maps can be created from the objects that were created as a list of distributions. The meaning of the objects created as list of distributions is the grouping of the distributions into objects.

Each specific representation of the map depends on the specific need and on the specific program for creating the specific representation of the map. For example, some specific representations of the maps include polygon-like shapes, whereas other specific representations of the maps include simpler shapes such as convex hulls.

Building the specific representations such as but not limited to polygon-like shapes and convex hulls from the list of distributions are carried out according to algorithms available in the literature.

One possibility is when
the new object o_{new},
the updated object o_{updated}, and
the updated merged object o_{m-merged-updated}
   are created out by the means μₙ of corresponding Gaussian distribution.

Other possibility is when
the new object o_{new}
the updated object o_{updated}, and
the updated merged object o_{m-merged-updated}
are created from two points selected oₙ the major axis of the corresponding Gaussian distribution which correspond to a certain probability, e.g., the 2 sigma points, or any other multiple of sigma of the main axis.

When creating
the new object o_{new}
the updated object o_{updated}, and
the updated merged object o_{m-merged-updated}
from two sigma points, in one variant, the corresponding Gaussian distribution has 2*k dimension.

Other possibility is when
the new object o_{new}
the updated object o_{updated}, and
the updated merged object o_{m-merged-updated}
are created from a specific number L of sensor data points Pr of the corresponding Gaussian distribution, said specific number L being sampled from a hyper ellipse corresponding to a certain probability.

The number of new points Pr_{new} are adjusted taking into consideration to not over-fit the distributions in the final map.

The particular advantage of increasing the number of new points Pr_{new} is the more accurate specific map representation while saving memory and computing power resources, enabling use of the invention to process raw sensors data by a wider range of data processing hardware.

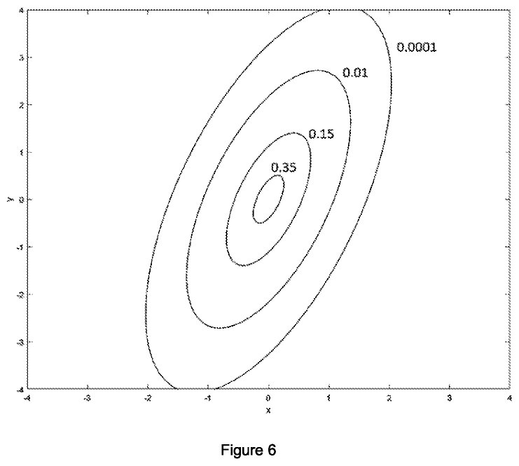

FIG. 6 depicts a suggestive image of the above-captioned embodiment detailing the construction of the plurality of objects oₙ based oₙ the ellipses. Using the constructed ellipses to construct or update the plurality of objects oₙ, e.g., convex hulls or polygons, can be done similar to using the points where the mean of the Gaussian distributions represents the point location.

However, if the ellipse is large, corresponding to a large variance, then more sensor data points are used to construct the object such as two points from the major axis of the ellipse or more sensor data points from the contour of the ellipse. This ellipse is defined based on a particular Gaussian distribution gₙ and a particular probability prob(Pr, gₙ), where the probability determine which ellipse from the Gaussian distribution is selected.

Choosing the particular probability is important because a very small probability leads to an ellipse which covers the whole x, y plane, in case of 2D, whereas choosing a large probability means leads to the mean only. Selecting the particular probability prob(Pr, gₙ) can be also done based oₙ the cumulative distribution function CDF, where it can be chosen the percentage of the points which that should be included in the object.

In a second aspect of the present disclosure, it is provided a data processing hardware being configured to carry out the steps of the method according to any of the embodiments.

In an embodiment, the data processing hardware is further configured to be included in a sensor, having the advantage of using the processor of the sensor for carrying out the method of the present disclosure.

The lightweight representation of the static environment in any of its variants described above can be sent to a drive system of a vehicle in communication with the data processing hardware.

While the description of the method was disclosed in detail in connection to example embodiments, those skilled in the art will appreciate that various modifications and alterations of the present disclosure will be apparent without departing from the essential scope to the teaching of the present disclosure and without diminishing its advantages. It is therefore intended that such modifications and alterations be covered by the appended claims.

### LIST OF SYMBOLS

Pr_{new}—a new sensor data point received from the at least one sensor
Pr_{n-new}—a number n of new sensor data points
Pr—an initial plurality of sensor data points
gₙ—an initial plurality of Gaussian distributions
g_{n-updated}—the updated plurality of Gaussian distributions
G—a distributions buffer comprising a plurality of Gaussian distributions
g—each Gaussian distribution of the plurality of Gaussian distributions G
Dd—the distribution distance between the new sensor data point Pr_{new} and each Gaussian distribution g
Ddₘᵢₙ—a predetermined distribution distance threshold
g_{new}—a new Gaussian distribution including the new sensor data point Pr_{new}
g₁—the single Gaussian distribution fulfilling the distribution distance condition Dd<Ddₘᵢₙ
g_{1-updated}—the updated single Gaussian distribution including the new sensor data point Pr_{new}
g₁, g₂, gₘ—the at least two Gaussian distributions fulfilling the distribution distance condition Dd<Ddₘᵢₙ
g_{m-merged}—the merged Gaussian distribution of the at least two Gaussian distributions
g₁, g₂, . . . , gₘ
g_{m-merged-updated}—the updated merged Gaussian distribution of the merged Gaussian distribution g_{m-merged} including the new sensor data point Pr_{new}
O—a buffer comprising a plurality of objects
oₙ₋ᵢₙᵢₜᵢₐₗ—an initial plurality of objects created as a list of distributions from the initial plurality Gaussian distributions gₙ
o_{n-updated}—the updated plurality of objects created based on updated plurality of Gaussian distributions g_{n-updated}
oₙ—the plurality of objects created by using the initial plurality Gaussian distributions gₙ, and updated plurality of Gaussian distributions g_{n-updated}
Do—the object distance computed from the updated distribution to each object o of the initial plurality of objects oₙ₋ᵢₙᵢₜᵢₐₗ
Doₘᵢₙ—the predetermined object distance threshold
o_{new}—the new object generated by assigning the new Gaussian distribution g_{new}
o₁—the single object fulfilling object distance condition Do<Doₘᵢₙ
o_{1-updated}—the updated single object o₁ including the updated distribution
oₘ—the multiple objects fulfilling object distance condition Do<Doₘᵢₙ
o_{m-merged}—the merged object including the multiple objects oₘ fulfilling object distance condition Do<Doₘᵢₙ
o_{m-merged-updated}—the updated merged object of the merged object including the updated distribution.

1. A computer-implemented method for processing sensor data points, comprising by data processing hardware:
1.1 initializing, by data processing hardware, a distributions buffer G for storing an initial plurality of Gaussian distributions gₙ, each Gaussian distribution g comprising an initial plurality of sensor data points Pr received sequentially from at least one sensor, each Gaussian distribution g having an associated predetermined distribution distance threshold Ddₘᵢₙ;
1.2 sequentially acquiring, by the data processing hardware, a new sensor data point Pr_{new} from the at least one sensor and computing a distribution distance Dd between the new sensor data point Pr_{new} and each Gaussian distribution g;
1.3 verifying, by the data processing hardware, for each Gaussian distribution g if the distribution distance Dd fulfills a distribution distance condition Dd<Ddₘᵢₙ, respectively distribution distance
Dd<the associated predetermined distribution distance threshold Ddₘᵢₙ;
1.3.1.1 if no Gaussian distribution g fulfills the distribution distance condition Dd<Ddₘᵢₙ, generating, by the data processing hardware, a new Gaussian distribution g_{new}, including the new sensor data point Pr_{new},
1.3.1.2 if the distribution distance condition Dd<Ddₘᵢₙ is fulfilled by a single Gaussian distribution g₁, updating, by the data processing hardware, the single Gaussian distribution g₁ by adding the new sensor data point Pr_{new}, generating an updated single Gaussian distribution g_{1-updated},
1.3.1.3 if the distribution distance condition Dd<Ddₘᵢₙ is fulfilled by at least two Gaussian distributions g₁, g₂, . . . gₘ, merging, by the data processing hardware, the at least two Gaussian distributions g₁, g₂ . . . gₘ, generating a merged Gaussian distribution g_{m-merged}, and updating, by the data processing hardware, the merged Gaussian distribution g_{m-merged} by adding the new sensor data point Pr_{new}, generating an updated merged Gaussian distribution g_{m-merged-updated},
1.4 updating, by the data processing hardware, the initial plurality of Gaussian distributions gn by including the new Gaussian distribution g_{new}, or the updated single Gaussian distribution g_{1-updated}, or the updated merged Gaussian distribution g_{m-merged-updated}, and
generating, by the data processing hardware, an updated plurality of Gaussian distributions g_{n-updated} in the distributions buffer G,
wherein the acts 1.2., 1.3., and 1.4. are repeated for a number n of new sensor data points Pr_{n-new}.

2. Computer-implemented method according to claim 1, wherein the distribution distance Dd is a Euclidian distance between the new sensor data point Pr_{new} and a mean μ_{g} of each Gaussian distribution g.

3. Computer-implemented method according to claim 1, wherein the distribution distance Dd is a probability of the new sensor data point Pr_{new} in respect to each Gaussian distribution g as follows:
$${D}_{d} = prob ( {Pr}_{new} , {g}_{n} ) = 𝒩 ( {Pr}_{new} ; {μ}_{n} , {\sum }_{n} ) = {( 2 π )}^{- \frac{k}{2}} det {( {\sum }_{n} )}^{- \frac{1}{2}} exp ( - \frac{1}{2} {( P {r}_{new} - {μ}_{n} )}^{T} {\sum }_{n}^{- 1} ( P {r}_{new} - {μ}_{n} ) )$$
where: [symbol]
(Pr_{new}; μₙ, Σₙ) is the probability that the new point Pr_{new} is generated from each Gaussian distribution g;
Pr_{new} is a new sensor data point, being a vector of k entries;
μₙ is the mean of each Gaussian distribution g, being a vector of k entries;
Σₙ is the covariance of each Gaussian distribution g, being a (k×k) matrix;
^{T} is the transpose.

4. Computer-implemented method according to claim 1, wherein the distribution distance Dd is computed using a Mahalanobis distance formula.

5. Computer-implemented method according to claim 1, wherein a sequential update of the updated single Gaussian distribution g_{1-updated}, and the updated merged Gaussian distribution g_{m-merged-updated} by sequentially adding a number n of new sensor data points Pr_{n-new} are carried out by the formulas:
$${μ}_{{g}_{n - updated}} = \frac{n - 1}{n} {μ}_{{g}_{n}} + \frac{1}{n} {Pr}_{n - new}$$
$$and$$
$${\sum }_{{gn}_{updated}} = \frac{n - 2}{n - 1} {\sum }_{{g}_{n}} + \frac{1}{n} Δ {Δ}^{T} ,$$
$$and$$
$$Δ = {Pr}_{{n - new}_{}} - {μ}_{{g}_{n}}$$
where:
μ_{gn} is a mean of any of the single Gaussian distribution g₁, and the merged Gaussian distribution g_{m-merged};
Σ_{gn} is a covariance of any of the single Gaussian distribution g₁ and a merged Gaussian distribution g_{m-merged};
μ_{gn-updated} is a mean of any of the updated single Gaussian distribution g_{1-updated}, and the updated merged Gaussian distribution g_{m-merged-updated};
Σ_{gn-updated} is a covariance of any of the updated single Gaussian distribution g_{1-updated}, and the updated merged Gaussian distribution g_{m-merged-updated}; and
^{T} is the transpose.

6. Computer-implemented method according to claim 1, wherein the new sensor data point Pr_{new} is provided with a covariance matrix Σ_{Pr}_{_{new}} forming a sensor data points Gaussian distribution N_{Pr}_{_{new}}(μ_{Pr}_{_{new}},Σ_{Pr}_{_{new}}) and the distribution distance Dd is computed between each Gaussian distribution g and the sensor data points Gaussian distribution N_{Pr}_{_{new}} using a Kullback-Leibler divergence or a Bhattacharyya distance.

7. Computer-implemented method according to claim 1, wherein the merging of the at least two Gaussian distributions g₁, g₂ . . . gₘ is carried out by successive merging pairs of two distributions from at least two Gaussian distributions g₁, g₂ . . . gₘ generating a merged Gaussian distribution g_{m-merged}, by weighting mean and variance of the two distributions from respective pairs of two distributions.

8. Computer-implemented method according to claim 1, wherein a lightweight representation of a static environment comprising a plurality of objects oₙ from a buffer O is created by using the initial plurality Gaussian distributions gₙ, and updated plurality of Gaussian distributions g_{n-updated} from the distributions buffer G in the following carried out by the data processing hardware:
1. Defining an initial plurality of objects oₙ₋ᵢₙᵢₜᵢₐₗ as a list of distribution from the initial plurality Gaussian distributions gₙ,
2. Receiving from the distributions buffer G an updated distribution from the updated plurality of Gaussian distributions g_{n-updated}, comprising: the new Gaussian distribution g_{new}, the updated single Gaussian distribution g_{1-updated}, or the updated merged Gaussian distribution g_{m-merged-updated},
and computing an object distance Do from the updated distribution to each object o of the initial plurality of objects oₙ₋ᵢₙᵢₜᵢₐₗ;
3. Verifying if the updated distribution satisfies an object distance condition Do<Doₘᵢₙ, namely if the object distance Do<a predetermined object distance threshold Doₘᵢₙn and updating the initial plurality of objects oₙ₋ᵢₙᵢₜᵢₐₗ, generating an updated plurality of objects o_{n-updated} depending on the type of updated distribution as follows:
8.3.1. When the updated distribution is the new Gaussian distribution g_{new}, the updating of the initial plurality of objects oₙ₋ᵢₙᵢₜᵢₐₗ is carried out as follows:
if the updated distribution does not satisfy the object distance condition Do<Doₘᵢₙ in respect to any object from the initial plurality of objects oₙ₋ᵢₙᵢₜᵢₐₗ, generating a new object o_{new} by assigning the new Gaussian distribution g_{new} and saving the new object o_{new} in the objects buffer O;
if the updated distribution satisfies the object distance condition Do<Doₘᵢₙ in respect to a single object o₁, updating of the single object o₁ by assigning the new Gaussian distribution g_{new}, generating an updated single object o_{1-updated}, and saving the updated single object o_{1-updated} in the objects buffer O;
if the updated distribution satisfies the object distance condition Do<Doₘᵢₙ in respect to multiple objects oₘ of the initial plurality of objects oₙ₋ᵢₙᵢₜᵢₐₗ, merging the multiple objects oₘ generating a merged object o_{m-merged}, updating the merged object o_{m-merged} by assigning new Gaussian distribution g_{new} generating an updated merged object o_{m-merged-updated} and saving the updated merged object o_{m-merged-updated} in the objects buffer O;
8.3.2. When the updated distribution is the updated single Gaussian distribution g_{1-updated}, the updating of the initial plurality of objects oₙ₋ᵢₙᵢₜᵢₐₗ is carried out by updating the corresponding the object o comprising the single Gaussian distribution g₁, generating an updated object o_{updated}, and saving the updated object o_{updated} in the objects buffer O;
8.3.3. When the updated distribution is the updated merged Gaussian distribution g_{m-merged-updated}, the updating of the initial plurality of objects oₙ₋ᵢₙᵢₜᵢₐₗ is carried out as follows:
if the updated distribution satisfies the object distance condition Do<Doₘᵢₙ in respect to a single object o₁, updating of the single object o₁, generating an updated single object o_{1-updated} by including the updated distribution, and saving the updated single object o_{1-updated} in the objects buffer O;
if the updated distribution satisfies the object distance condition in respect to multiple objects oₘ of the initial plurality of objects oₙ₋ᵢₙᵢₜᵢₐₗ, merging the multiple objects oₘ generating a merged object o_{m-merged}, updating the representation of the merged object o_{m-merged} by including the updated distribution generating an updated merged object o_{m-merged}-updated and saving the updated merged object o_{m-merged-updated} in the objects buffer O;
4. Creating and permanently updating the lightweight representation of the static environment by exporting from the objects buffer O: the new object o_{new}, or the updated single object o_{1-updated}, or the updated merged object o_{m-merged} into a user interface for immediate use,
wherein acts 8.2. to 8.4. are repeated for the number n of new sensor data points Pr_{n-new}.

9. Computer-implemented method according to claim 8, wherein the new object o_{new}, the updated object o_{updated}, and the updated merged object o_{m-merged-updated} are created out by the means μₙ of corresponding Gaussian distribution.

10. Computer-implemented method according to claim 8, wherein the new object o_{new}, the updated object o_{updated}, and the updated merged object o_{m-merged-updated} are created from two points selected on a major axis of the corresponding Gaussian distribution which correspond to a certain probability.

11. Computer-implemented method according to claim 10, wherein the corresponding Gaussian distribution has 2*k points of each Gaussian distribution g, where k is a dimension of a corresponding Gaussian distribution.

12. Computer-implemented method according to claim 8, wherein the new object o_{new}, the updated object o_{updated}, and the updated merged object o_{m-merged-updated} are created from a specific number L of sensor data points Pr_{L} of the corresponding Gaussian distribution, the specific number L being sampled from a hyper ellipse corresponding to a certain probability.

13. Computer-implemented method according to claim 8, wherein the lightweight representation of the static environment is sent to a drive system of a vehicle in communication with the data processing hardware.

14. A data processing hardware being configured to carry out the method according to claim 1.

15. The data processing hardware of claim 14 being further configured to be included in a sensor.

16. The data processing hardware of claim 15, wherein the sensor comprises an ultrasonic sensor.
